(19) United States
(12) Patent Application Publication
(10) Pub. No.: US 2026/0185644 A1
(43) Pub. Date: Jul. 2, 2026

(54) ADAPTED LASER PIG WITH AGITATION AND CIRCULATION MECHANISM FOR THERMAL CONTROL IN SUBSEA OPERATIONS

(71) Applicant: PETRÓLEO BRASILEIRO S.A. - PETROBRAS, Rio de Janeiro (BR)

(72) Inventor: Mario Germino Ferreira Da Silva, Rio de Janeiro (BR)

(21) Appl. No.: 19/426,166

(22) Filed: Dec. 19, 2025

(30) Foreign Application Priority Data
Dec. 26, 2024 (BR) 20 2024 027287 6

(51) Int. Cl. F16L 55/32; F16L 55/38; F16L 101/12

(52) U.S. Cl. CPC F16L 55/32; F16L 55/38; F16L 2101/12

(57) ABSTRACT

The present utility model relates to a laser pig adapted with a circulation and agitation mechanism for thermal control in subsea operations, designed to improve the efficiency of the scale removal process in subsea pipelines and equipment. The laser pig is composed of a battery, a set of laser diodes, collimators, longitudinal channels and fan-type devices installed at the ends of the channels. These components work in an integrated manner to promote the circulation and agitation of the treatment fluids, ensuring temperature homogenization around the laser pig during its operation.

### CROSS REFERENCE TO RELATED APPLICATIONS

The present application claims priority to BR Pat. App. No. 2020240272876 filed on Dec. 26, 2024, which is hereby incorporated by reference in its entirety.

### FIELD OF THE UTILITY MODEL

This utility model falls within the technical field of subsea production systems, in particular in the maintenance and operation of subsea pipelines and equipment used for the flow of oil and gas. More specifically, it proposes a laser pig adapted with a circulation and agitation mechanism to maintain the ideal temperature of chemical treatment solutions, increasing the efficiency of scale removal reactions in extreme conditions, such as in the pre-salt layer.

### BACKGROUND OF THE UTILITY MODEL

Subsea equipment such as production lines, wet Christmas trees (WCTs) and manifolds are subject to saline scaling that reduces operational efficiency and can cause blockages. This scaling is removed by means of chelating solutions, whose efficiency depends directly on the temperature during the complexation reaction.

Currently, pigs are used both to clean and to inspect the interior of the pipeline. In the latter case, they are called instrumented pigs. Pigging operations are part of a mandatory operational practice for preserving the internal condition of a pipeline, which aims to remove accumulations of deposits (such as paraffin and corrosion residues) and liquid phases (such as accumulated condensate) inside the pipeline, in addition to monitoring the condition of the internal walls of the pipeline for the occurrence of corrosive processes. They can range from a simple foam cylinder to a more complex device such as a cylindrical metal structure (chassis) that uses a transverse disc as a guide and seal.

In this sense, conventional pigging systems, even those with laser heating, face difficulties in the uniform distribution of heat, especially at depths greater than 700 meters, where the seabed temperature is approximately 4° C. In addition, there are challenges associated with heat exchange between treatment fluids and environment.

Currently, there are some solutions for internal pipeline cleaning known in the state of the art, such as those indicated below.

The document U.S. Pat. No. 11,578,563 B2 describes a tubular jetting device designed to facilitate the removal of debris in wells, such as in drilling operations. This device consists of a tubular structure with several ports and channels for fluid circulation. Its main objective is to improve the efficiency of cleaning the annular space of the well, where debris accumulates during operations.

WO 2021168524 A1 discloses a cylindrical device designed to clean the interior of production tubing, such as the production string. This equipment can travel inside a production string, being lowered by gravity and raised by means of a cable, heating the fluid around the production string, along the scaled region, to maintain the temperature necessary for the reaction of the chelating agents, removing the scaling.

Finally, BR 102019026153 A2 proposes a laser pig equipped with a heating mechanism, to be used in the removal of scaling from subsea production systems such as production lines, manifolds and ANMs. The laser pig has a mechanism to heat the liquid around it, such as inside the production line. The mechanism will consist of a battery, fiber optic cables, laser diodes, collimators and a temperature sensor.

As can be seen, all solutions show the same technical problem related to the loss of efficiency in the scaling removal process due to the absence of adequate heat distribution mechanisms and excessive cooling of the treatment solutions, especially at great depths, compromising the chemical reactions necessary for the effective removal of scaling salts. Unlike what is already known in the state of the art, the present utility model proposes a laser pig adapted with a mechanism for circulating and agitating fluids for thermal control and temperature homogenization, maintaining the efficiency of the scale removal fluids.

### SUMMARY OF THE UTILITY MODEL

The present utility model relates to a laser pig adapted with a circulation and agitation mechanism for thermal control in subsea operations, comprising: a battery; a set of laser diodes; a set of collimators; a set of longitudinal channels traversing the laser pig; a set of fan-type devices located at the ends of the longitudinal channels; and temperature sensors for continuous monitoring.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present utility model will be described below with reference to typical embodiments thereof and also with reference to the attached drawings.

FIG. 1 is a representation of the laser pig from the state of the art.

FIG. 2 is a representation of the adapted laser pig with circulation and agitation mechanism of the present utility model operating in a pipe with scaling adhered to the walls.

FIG. 3 shows details of the adapted laser pig, including battery, laser diodes, collimators, longitudinal channels and fan-type devices, according to the present utility model.

FIG. 4 illustrates the side cutaway and front views of the laser pig, highlighting the positioning of the fan-type devices positioned alternately to balance the flow, according to the present utility model.

FIG. 5 represents an enlarged view of the internal recesses in the longitudinal channels for fixing the fan-type devices, according to the present utility model.

### DETAILED DESCRIPTION OF THE UTILITY MODEL

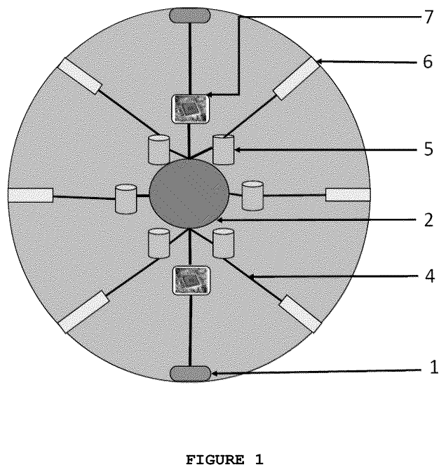

FIG. 1 shows a laser pig from the state of the art. In this sense, it is noted that said pig comprises: a battery (2), fiber optic cables (4), laser diodes (5), collimators (6), a temperature sensor (1) and electronics (7), so that the components such as batteries, fiber optic cables, collimators and sensors are mounted in a spherical rubber module, interconnected with each other, forming an assembly that allows elastic deformation to allow its passage through the equipment of the subsea system.

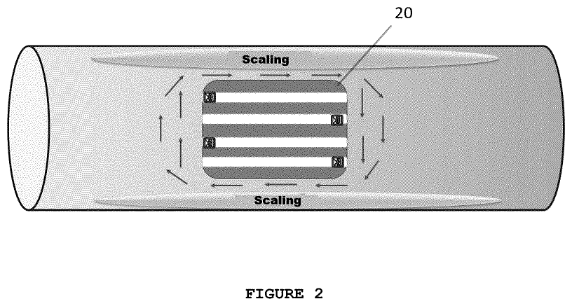

In this sense, the present utility model relates to a set of modifications introduced in the laser pig to include a circulation and agitation mechanism, allowing the homogenization of the solution temperature around the additive throughout its operation, as can be seen in FIG. 2, which shows a view of the laser pig (20) adapted with an agitation and circulation mechanism driven inside a pipe with scaling adhered to its walls.

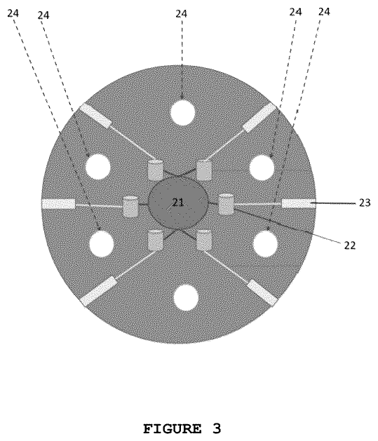

In more detail, as can be seen in FIG. 3, the laser pig (20) adapted with an agitation and circulation mechanism for thermal control in subsea operations has the following structures:
a battery (21);
a set of laser diodes (22);
a set of collimators (23);
a set of longitudinal channels (24) traversing the laser pig;
a set of fan-type devices (25) at the ends of the longitudinal channels (24); and
temperature sensors for continuous monitoring.

The inclusion of longitudinal channels (24) allows the circulation of scale-removing fluids through them, which improves temperature uniformity around the laser pig (20).

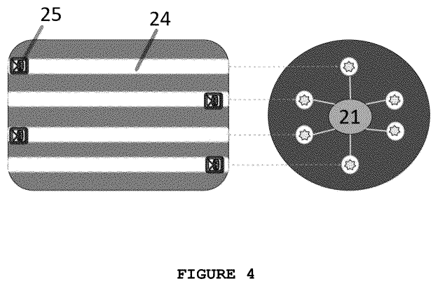

Fan-type devices (25) are connected to the battery (21) and promote fluid agitation through the longitudinal channels (24) of the fluid circulation and agitation mechanism, as shown in FIG. 4, which shows the side cutaway and front view of the laser pig (20). Three fan-type devices (25) are positioned on each side of the laser pig, in alternating orientations, to balance the flow and prevent unwanted displacement of the pig within the production line.

This fan-type device (25) aims to facilitate fluid homogenization and thus also facilitate temperature uniformity of the chelating solution within the duct around the chelating agent during the removal of scale-forming sulfate salts.

Furthermore, it should be noted that, preferably, like the laser diodes (22), the fan-type devices (25) are powered by the same battery (21). Alternatively, depending on the dimensions of the project, each of the fan-type devices (25) may have an independent battery.

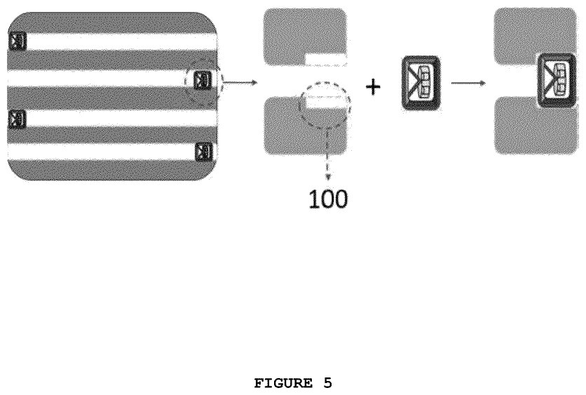

To accommodate and fix the fan-type devices (25) in the longitudinal channels (24) of the laser pig (20), internal recesses (100) are made in said longitudinal channels, as can be seen in FIG. 5, which shows an enlarged view of this structure.

In this way, the laser pig (20) adapted with a circulation and agitation mechanism provides:
maintenance of the ideal temperature of the chelating solutions, increasing the efficiency of scale removal;
reduction of operating time and associated costs; and
lower environmental impact due to the optimization of chemical treatments.

What is claimed is:

1. A laser pig, comprising:
a battery;
a set of laser diodes;
a set of collimators;
a set of longitudinal channels traversing the laser pig;
a set of fan-type devices located at ends of the longitudinal channels; and
temperature sensors.

2. The laser pig, according to claim 1, wherein the longitudinal channels allow circulation of descaling fluids, promoting uniformization of temperature around the laser pig.

3. The laser pig, according to claim 1, wherein the fan-type devices are connected to the battery (21) and promote agitation of fluid through the longitudinal channels), balancing flow to avoid unwanted displacements.

4. The laser pig, according to claim 1, wherein the fan-type devices are one of:
powered by the battery, or
powered by independent batteries for each fan-type device.

5. The laser pig, according to claim 1, wherein the fan-type devices are fixed in the longitudinal channels (by means of internal recesses, providing greater structural stability.

6. The laser pig, according to claim 1, wherein the fan-type devices are arranged, clockwise, at opposite ends of the longitudinal channels.

7. The laser pig according to claim 1, wherein the laser pig is adapted with a circulation and agitation mechanism for thermal control in subsea operations.
